(19) United States
(12) Patent Application Publication
(10) Pub. No.: US 2007/0244788 A1
(43) Pub. Date: Oct. 18, 2007

(54) Method of Storing Data Used in Backtesting a Computer Implemented Investment Trading Strategy

(75) Inventor: Gavin Robert Ferris, County Down (IE)

Correspondence Address: SYNNESTVEDT LECHNER & WOODBRIDGE LLP, P O BOX 592, 112 NASSAU STREET, PRINCETON, NJ, 08542-0592, US

(73) Assignee: CRESCENT TECHNOLOGY LIMITED, Dublin (IE)

(21) Appl. No.: 11/718,751

(22) PCT Filed: Nov. 8, 2005
(86) PCT No.: PCT/GB05/04315

§ 371 Date: May 21, 2007

(30) Foreign Application Priority Data
Nov. 8, 2004 (GB) 0424659.1

(51) Int. Cl. G06Q 40/00

(52) U.S. Cl. 705/36 R

(57) ABSTRACT

Hence, the invention is a contribution to the field of designing computer implemented systems that test how different trading algorithms work when fed historic data (‘backtesting’). It teaches an efficient and effective data representation that comprises two elements. First, an object-based representation of each trading strategy; each object is instantiated as a ‘strategy instance’. Secondly, a pairing between any tradable instrument and any strategy instance; the pairing is called an ‘account’. A key advantage of the data representation is that the data in each account is held in a matrix format; these are easily and efficiently stored in standard relational databases. Further, operating the method involves large scale matrix operations, which are fast and computationally efficient within a matrix based language. Conventional approaches do not store data in a matrix format and hence fail to achieve the computational efficiency possible with the present invention.

### BACKGROUND OF THE INVENTION

1. Field of the Invention

This invention relates to a method of storing data used in ‘backtesting’ a computer implemented investment trading strategy for a portfolio; the invention is therefore a contribution to the field of designing computer implemented systems that test how different trading algorithms work when fed historic portfolio data (‘backtesting’). It teaches an efficient and effective data representation.

Structure of this Document: We begin by presenting a brief review of the existing approaches to portfolio backtesting that are currently available, and then we show whey these approaches do not generally meet the requirements of systematic multi-strategy hedge funds (‘multi-strats’) in an efficient manner. Next, we describe in more detail the specific requirements that sophisticated, systematic multi-strategy hedge funds have of a backtesting system, including the enumeration of 15 specific points. Following this, we present an implementation of the present invention called the xTest system in detail (including its assumptions, underlying architecture and dataflow), and we show how this approach both does meet the needs of multi-strats and presents significant advantages compared to the current art. Finally, we provide a brief summary and review.

2. Description of the Prior Art

Systematic multi-strategy hedge funds are loosely regulated investment pools, generally open only to institutional and high-net-worth investors, which attempt (for the most part) to make absolute returns utilising algorithm-driven trading rather than returns relative to a benchmark, the norm for e.g. equity mutual funds. These algorithms specify the amount of each traded instrument to buy or sell at any time, given a set of input parameters (generally, set by the human manager of the fund) and a set of input data (usually, at least historical and current prices, but possibly also fundamentals and other information). Multi-strategy hedge funds derive much of their additional ‘edge’ from internal diversification, and through the use of a common money management framework to manage capital assignment between the set of investment strategies in use. Diversification involves the use of multiple, largely independent trading strategies, that may be diversified without limitation by algorithm, geography, trading timescale, or underlying instruments used.

For multi-strats, a key challenge is to determine, before trading ‘live’, how successful a potential strategy with a given set of parameterization is likely to be. This is generally determined by measuring how the strategy would have performed, given historical market prices as input—a process conventionally referred to as ‘backtesting’. Systematic funds have an advantage over their ‘discretionary’ (human-decision-driven) counterparts in this area, because the algorithmic nature of their trading rules (particularly, where the algorithms have been embodied as computer software) makes it possible to recreate precisely what a given strategy ‘would have done’ when presented with a wide variety of either historical or simulated input data. The discretionary trader, by contrast, will have a much harder job providing such an analysis in a successful, error-free and unbiased manner. More controversially, the ability exists for funds to check a particular strategy with different sets of input parameters, to see which performs ‘best’ according to some pre-determined objective function (best overall risk-adjusted return, etc.). The risk with this approach of course is overfitting, where the parameters have been in effect chosen to produce a good result given the data, as a consequence of which the parameterized strategy has much less efficacy when subjected to ‘out of sample’ data.

While a number of third-party software packages providing automated backtesting facilities do currently exist, they do not provide a number of key features particularly as regards true ‘cross-sectional’ portfolio simulation, coupled with sophisticated and programmable money management) that multi-strategy systematic hedge funds require. In response to this requirement, Crescent has developed the xTest backtesting platform, the innovative architecture of which is the subject of this specification.

The Backtesting Requirements of Multi-Strategy Hedge Funds

Systematic multi-strategy hedge funds, as described above, have a general requirement to test their trading strategies against historically-derived input data, such that the results match, as closely as possible, what would actually have been achievable trading those same strategies ‘live’. In more detail, funds require:
1. The ability to specify trading strategies in a systematic manner, generally using some form of programming language that enables actions such as purchases and sales to be handled in a straightforward manner.
2. The ability to specify money management strategies in a systematic manner, generally through the use of a programming language. The backtesting framework must provide an integrated and coherent methodology for dealing with money management that does not involve circularity.
3. The ability to compare multiple <strategy, instrument> tuples (pairings) simultaneously, where these are determined by the user as just specified, and where a common money management framework is used in both cases.
4. That the backtesting framework be able to deal with both instruments that have a market value (such as equities) and those which do not (being ‘off balance sheet’, such as commodity futures and CFDs).
5. That the backtesting framework be able to manage the handling of foreign exchange (to allow trading of e.g. a basket of futures that are denominated in different currencies), and also to handle short term interest rates (generally based around LIBOR) for each currency.
6. The ability to generate key portfolio metrics (including metrics of risk), and have these available to the money management software (specified per point 2).
7. As a particular (but important variant of the above point), the ability to use VaR (value at risk) as an input to these functions.
8. The ability to export data in detail into a format that may be easily reviewed (e.g., into a spreadsheet).
9. The ability to support accurate ‘performance bond’ margin requirements for instruments in historical trading, and to track daily margin allocation (of both types—margin as loan collateral as regards equities, and margin as ‘good faith deposit’ as regards futures and similar instruments).
10. The ability to support a comprehensive trading cost analysis (including slippage, spread and commissions). This should include the ability to estimate volatility-based slippage and spread.
11. The ability to deal with liquidity—that is, the ability of the underlying market to process a specific volume of trade within a maximum target price impact.
12. The ability to deal with fees correctly. Hedge funds generally charge a regular management fee (e.g., 2% per annum of assets, taken pro rata monthly) and a less regular performance fee (e.g., 20% of net new profits). Handling of the performance fee must deal with tracking the ‘high water mark’ of previous profits.
13. The ability to operate in both an end-of-day data mode (in which instrument price data in the form <open, high, low, close, volume, open interest (opt)> is supplied to the strategy, and in an intraday mode, in which hourly, minute-by-minute or tick data (or some other aggregation frequency) is provided.
14. The ability to run the backtesting system in parallel with a set of real trades, to enable more accurate estimation of performance parameters. This is particularly important in the estimation of trade impact as a function of market liquidity.
15. That the backtesting system makes handling of the trading strategies and, crucially, the portfolio dynamics, efficient for the fund. Now, in one sense, pretty much any framework that provides the user access to a general programming language enables almost all behaviors that might be envisaged to be implemented. However, it is only where that framework's object model and dataflow are apposite to the problem domain, that the required behaviours can be implemented in an efficient manner. This is a critical point.

Of course, in addition to these requirements, systematic multi-strats will generally require that the system is easy to use and can rapidly demonstrate to them the advantages (or otherwise) of adding a particular strategy into an existing product mix. To derive this information, it is necessary however to re-simulate the performance of the full fund, rather than simply simulating the stand-alone performance of the candidate addition, due to the path dependencies inherent in any sophisticated approach to money management.

Let us now turn to review the current art in terms of commercially available backtesting systems. We will then compare the abilities of these systems against the list of requirements just specified.

Current Approaches to Portfolio Backtesting Known in the Art

A number of portfolio-based backtesting systems do exist currently. For example, ClariFI (http://www.clarifi.com) produces a relatively straightforward portfolio-based backtesting system named ModelStation. LMT provides a system (EXPO, see http://www.lmt-expo.com) that also supports limited portfolio operations through an add-in, including a certain amount of ‘what-if’ scenarios. Simpler ‘portfolio oriented’ approaches include Pikker (http://www.emporium-sw.com) and InvestmentStudio (http://www.investmentstudio.com) and WealthLab Developer (http://www.wealth-lab.com); these systems have only limited money-management capabilities.

Perhaps the broadest range of products exist as ‘portfolio extensions’ to essentially ‘single instrument’ backtesting platforms. Examples here are the PortfolioStream product from Rina Systems (http://www.rinafinancial.com) and TradeSim from Paritech (http://www.paritech.com). PortfolioStream is a plug-in for TradeStation (one of the most popular single-strategy-instrument backtesting products, which pioneered the EasyLanguage script for describing trading strategies, see http://www.tradestation.com), which extends its operation into the portfolio domain, and provides elementary currency management capabilities. TradeSim is a similar portfolio extension (with some limited money management capabilities) for MetaStock (also from Paritech; MetaStock is similar to TradeStation in that is primarily designed for single <instrument, strategy> pairs, rather than portfolios). There are a large number of other systems available (such as AmiBroker, see http://www.amibroker.com which offer a primarily single <strategy, instrument> development environment, with a portfolio capability primarily designed to track holdings, rather than contribute actively to money management.

In summary, the existing systematic backtesting art has tended to divide into three primary camps:
1. A relatively simple portfolio extension to what is essentially a ‘single instrument at a time’ trading platform, such as the Metastock-Tradesim combination or the Tradestation-PortfolioStream pairing. The PortfolioStream system does provide a degree of money management, but does not separate asset allocation and trade sizing. (We also include in this category very basic portfolio control system integrated into a platform which does not provide support for sophisticated money management, e.g., AmiBroker). Generally, such systems go little further than allowing the system developer to see the results of trading a strategy over multiple instruments, often with some degree of automated optimization involved.
2. An integrated portfolio trading system with a relatively limited rebalancing/allocation methodology. Wealth-Lab Developer, Pikker and InvestmentStudio are good examples of this style, where an inherently portfolio-centric API (application programming interface) is provided to the end user, through which theoretically they can code up any money management approach. However, without an appropriate framework and data flow/representation, any such implementation will be inefficient and time-consuming for a developer to create.
3. A more sophisticated portfolio analysis approach, such as ClariFI's ModelStudio or LMT's EXPO-Portfolio, which provides the capability to impose a degree of integrated portfolio money management based upon risk analysis. However (e.g. in the case of ClariFI's ModelStation) the lack of a clear allocation/sizing framework makes realistic operation of a multi-strategy, multi-time period approach difficult (unless the user codes everything explicitly, which takes us back to the limitations of the second class of backtesting package, above).
   Drawbacks of the Current Art

In general, there are a number of problems with the existing offerings when considered as backtesting tools for multi-strategy hedge funds. The most pertinent are as follows:
Generally, the approach to portfolio construction is relatively simplistic. Where some degree of automation is supported in this regard (such as with the Rina Systems product), a clear separation is not made between asset allocation and trade sizing; instead, these are bundled together under ‘money management’ (we will have more to say about this issue shortly).
A related point is not dealing correctly with the issue of ‘reservation’ of capital for a strategy that currently does not have a trade in progress; this is clearly an important issue to address but requires a separation of the average (or expected) performance of a <strategy instance, instrument> pairing in the longer term, the management of a given trade in the immediate term.
For the most part, currency and interest rate movements are not dealt with correctly, including the ability to implement a custom currency overlay of sweep program (the EXPO product provides a limited currency methodology, but things such as currency overlays and weekly sweeps have to be explicitly programmed, and local instrument LIBOR interest/carry charging is not explicitly supported).
Proper support for historical margining (e.g. of futures contracts) is in general not provided. This is important as margin requirements change over time and one cannot simply regard the current contract margin requirements as a proxy for the past.
Strategies that involve simultaneously managing a set of instruments in a single trade (covering processes all the way from long-short equity to full basket-based statistical arbitrage), are not handled by simple portfolio management systems (since the latter always tie a strategy and trading instrument together).
From the point of view of a sophisticated multi-strat, the ‘single instrument’ extension systems (type 1 in out summary above) are usually too simplistic for realistic use. Simple portfolio-centric systems (type 2) do not provide generally useful risk-control, and sophisticated portfolio management engines (type 3) tie the user into a framework that does not properly separate general allocation and trade sizing, meaning that in general the ‘money management’ software must be coded explicitly (dropping the user back into type 2 scenario).

Specifically as regards the 15 key requirements described earlier, we can see in FIG. 1 how each of the example systems we have introduced compares.

As may be appreciated, in the context of a systematic multi-strategy fund, these are serious drawbacks that generally prohibit the use of such products as part of the mainstream product development flow. Consequently, many systematic multi-strat hedge funds have resorted to creating their own backtesting platforms in house, in an attempt to achieve the appropriate degree of control. This approach is clearly inefficient.

Crescent's approach has been to develop a general backtesting framework, which we have termed xTest. xTest allows the user to attain sophisticated portfolio control in a flexible manner, while simultaneously benefiting from a significant efficiency gain (through the representation of data and the sequencing of simulation tasks).

### SUMMARY OF THE PRESENT INVENTION

In a first aspect, there is a method of storing data used in backtesting a computer implemented investment trading strategy;
wherein an object based data representation is used, the data representation comprising instances of a software object implementing a particular systematic trading strategy (‘strategy instances’), with a strategy instance being paired with a tradable instrument;
and wherein the data for each pairing of a strategy instance and an instrument is stored in a matrix format.

Hence, the invention is a contribution to the field of designing computer implemented systems that test how different trading algorithms work when fed historic data (‘backtesting’). It teaches an efficient and effective data representation that comprises two elements. First, an object-based representation of each trading strategy; each object is instantiated as a ‘strategy instance’. Secondly, a pairing between any tradable instrument and any strategy instance; the pairing is called an ‘account’.

A key advantage of the data representation is that the data in each account is held in a matrix format; these are easily and efficiently stored in standard relational databases. Further, operating the method involves large scale matrix operations, which are fast and computationally efficient within a matrix based language. Conventional approaches do not store data in a matrix format and hence fail to achieve the computational efficiency possible with the present invention.

The following further steps may be performed: (i) estimating a general trading performance associated with each strategy instance in order to allocate free capital to different strategy instances and (ii) separately determining how much of a given allocation associated with a given strategy instance should be utilised on a specific trade associated with a specific instrument. A key advantage of the data representation used in the present invention is that it is possible to separate capital asset allocation (which is specific to a trading strategy, but not a given instrument) from trade sizing (which is specific to both a trading strategy and a given instrument); this has not been possible with conventional approaches.

Each strategy instance can be interacted with via an API; the step of estimating a general trading performance associated with a software object is performed by polling that object over an API to determine one or more of an expected return, expected trade recommendation occurrence and expected holding period for that object. Multiple pairings, each between a strategy instance and an instrument, can be backtested in parallel.

The backtesting process can be modelled as a series of timeslots, each of which is broken up into phases; a portfolio is represented as a set of accounts, which each contain ledgers and state; each phase of the backtesting process has a set of allowed transactions that can operate on state and cashflows that can operate on ledgers.

Local and ‘root’ currencies can be handled within an account, with the option to have an explicit currency management routine provided by the user. The data representation is designed to be flexible in order to enable a strategy instance to be associated with a single account or with multiple accounts or to give the ability for an underlying instrument to be traded in one or more separate accounts by multiple strategies.

Backtesting requires a strategy instance not only to provide its trading decisions, but also estimates of its expected trading performance, characterised as probability distribution functions (PDFs) for trade recommendation arrival, trade holding time and return, and also (when recommending a specific trade) the return estimate PDF time-series for that particular trade. These estimates can be inferred automatically where the underlying strategy instance cannot provide them. These estimates can also be inferred automatically using a Monte Carlo simulation to create estimates of these PDFs, using either historical data (bootstrapped or sampled) or random generation via risk factors.

The use of an allocator routine to decide the amount of capital to assign to each strategy instance, and then a sub-allocator to assign to each account is possible. The allocator (based upon individual trade assessments at each timestep from the strategy instances) can pre-emptively allocate capital from other accounts (including potentially shutting out running trades, and then (based upon the relationship between the individual trade predicted ex ante performance and the general predicted strategy performance), to drive a trade sizing. It is also possible to use a VaR (value at risk) monitor on current positions, that can be made available to the various allocation and trade sizing routines, and which can also be used to run an overall risk control loop, whereby a master VaR target is set, and when this is exceeded then a global scaling factor is decreased according to an appropriate loop gain, to lower the size of all contracts.

Using risk control in the reverse manner is also possible, where a failure to meet the target risk causes an increase in the scaling factor. Using an estimation of a volatility→performance bond margin transfer function that enables a more accurate simulation is also possible.

An historical slippage and spread for trading that is based upon volatility is also possible. The slippage and spread model can be conformed to actual trading, by running the backtesting system in parallel with actual trading, and then using a Kalman filter to create a better estimate. This better model can then be used for subsequent backtesting. A liquidity constraint can be used, whereby the backtested system will not allow trading of more than a certain % (or other function) of volume or open interest.

An actual trading system, based upon the backtesting method can be created and deployed.

### BRIEF DESCRIPTION OF THE DRAWINGS

The present invention will be described with reference to the accompanying drawings, in which:

FIG. 1 is a table showing how the 15 backtesting requirements of hedge funds are currently met;

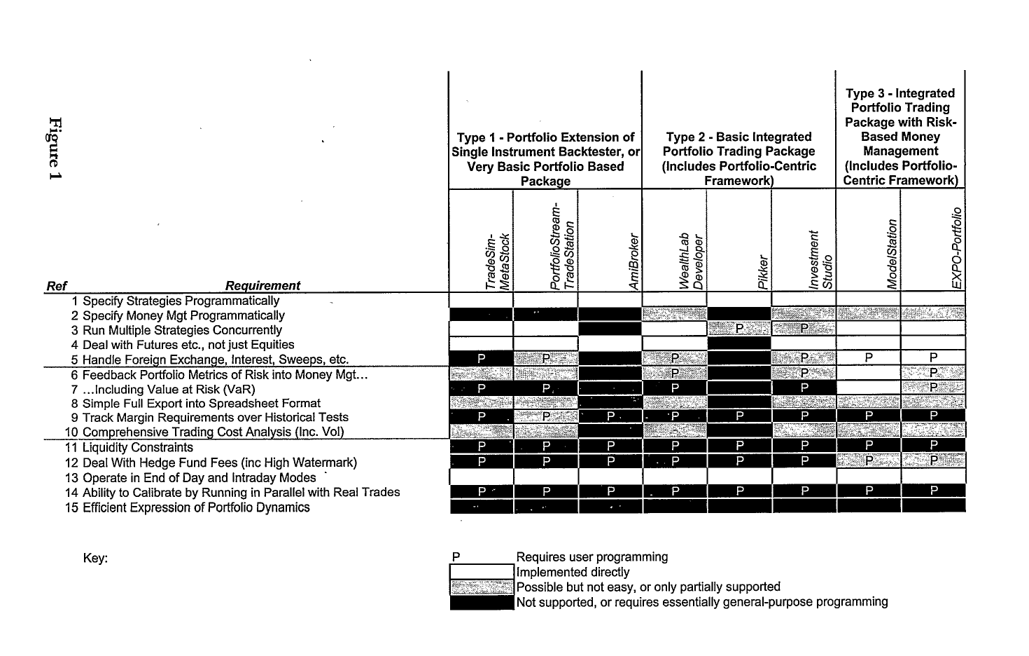

FIG. 2 is a schematic showing how strategy instances in xTest can cover multiple accounts, instruments may be traded by multiple strategy instances, and non ‘Root Currency’ accounts may be actual, or virtual (i.e., margined in the Root Currency, with a regular settlement sweep);

FIG. 3 is a spreadsheet output from xTest showing the main ledgers for a virtual local currency account;

FIG. 4 is a schematic showing how xTest systematically updates data structures in time slots and phases;

FIG. 5 shows the major data flows in the xTest framework, showing the split between capital allocation and trade sizing; and

FIG. 6 is the FIG. 1 table showing how the 15 backtesting requirements of hedge funds are currently met, together with a column indicating how those requirements are met by xTest.

### DETAILED DESCRIPTION

The xTest system aims to provide a unified framework for testing multiple <strategy instance, instrument> pairs (tuples) in parallel, under the umbrella of a common money management system. A ‘strategy instance’ refers to a single instance of an software object implementing a systematic trading strategy, with its own internal state. A money management system, as will be discussed later in more detail in this document, refers to an algorithm ultimately responsible for choosing the amount of overall capital to assign to each specific trade.

Both the trading strategy (or strategies) and the money management strategy may be user programmed. The system is currently available in a MATLAB embodiment (MATLAB is a third-party standard technical environment for matrix processing and scientific computation); however, the concepts and the data representation and flow presented are general and may be implemented in any general programming language.

xTest provides an efficient way for users (multi-strat system developers) to express both trading systems and the money management rules that control those systems, in a uniform manner that may be processed without circularity.

Portfolios, Accounts, Instruments and Strategies

The xTest methodology starts with a representation of a portfolio as a set of accounts. Each account contains information (cashflows, ledgers, transactions and net position; more of which shortly) regarding a single type of instrument (e.g. a Eurodollar future) traded by a single trading strategy instance (e.g. a particularly parameterized version of a long-term non-anticipatory trend following strategy; the strategies here may be completely independent algorithms, not simply differently parameterised instances of the same algorithm).

Now, any particular type of instrument (e.g. a long gilt future) may be traded by multiple, distinct strategy instances. In this case, there will be multiple accounts for that instrument type, one per distinct strategy instance. An account is denominated in a local currency (which is the currency of the underlying instrument). For example, a Eurodollar future account would be denominated in US dollars, whereas a UK long gilt future would require a sterling denominated account. Accounts are managed as a series of accounting ledgers, which are updated according to two tenors: a timestep, and a phase. There are five phases to each time step (of which more shortly). During each phase, a set of cashflows is generated for the account (arising as the result of strategy-directed trading activity, money management, or fees, interest and ancillary movements (such as dividends)). A set of position information state is updated at each phase for each account (including number of contracts held, average entry price, mark-to-market etc) based upon underlying transactions. A set of pricing information for the underlying information is also maintained within the state.

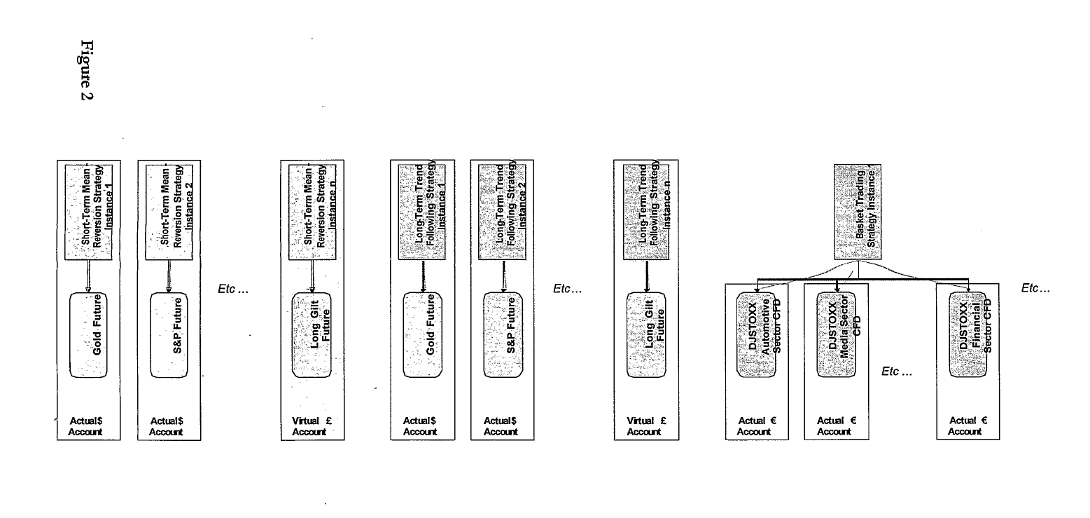

FIG. 2 shows how a trading strategy instance can be associated with a single account, or with multiple accounts: it shows that Strategy Instances May Cover Multiple Accounts, Instruments May Be Traded by Multiple Strategy Instances, and Non ‘Root Currency’ Accounts May Be Actual, or Virtual (i.e., Margined in the Root Currency, with a Regular Settlement Sweep).

The ledgers that are maintained for each account are:
The nominal cash balance of the account in the ‘root’ currency. This is generally US dollars. The cash balance tracks cash that has been assigned to the account (a particular strategy instance trading a particular type of instrument), but which is not currently being used for performance bond margin (on e.g. a futures position) or tied up in an instrument with market value (e.g. an equity). NB—it is possible for the cash position to be negative (for example, where an equity is purchased on margin).
The nominal cash balance of die account in local currency terms. For example, in the case of the long gilt future, this would be in pounds sterling. For situations where margin may be posted in the root currency (at an appropriate exchange rate) and all settlement flows are swept back into the root currency or paid to the root currency at end of day, these two ledgers suffice to describe the cash position (this will generally be true for trading futures institutionally). We refer such accounts these as ‘virtual local’ accounts.
An actual ‘free’ cash balance in the ‘root’ currency (e.g., US dollars). This records how much actual cash is held in dollars at that point. Its use is optional when toot currency margining and end-of-period sweeps are used (i.e. where virtual local accounts are used).
Similarly, an actual ‘free’ cash balance in the local currency (e.g., pounds sterling). This ledger records how much actual cash is held in sterling at that point. It is also optional where virtual local accounts are used.
The amount of the cash of the account that is currently allocated as performance bond margin (good faith deposit for futures). This may be local or virtual local currency denominated.
A ledger that contains the current market value of the instrument. ‘Off balance sheet’ instruments such as futures and CFDs do not utilise this ledger, since they are subject to daily settlement. Equities, bonds and other similar instruments, however, do utilise the ledger.
A derived ledger, the account equity. This is the sum of the local free cash, local performance bond margin and local market value. It essentially represents the amount of cash that the holder would have if the position were liquidated at that point.

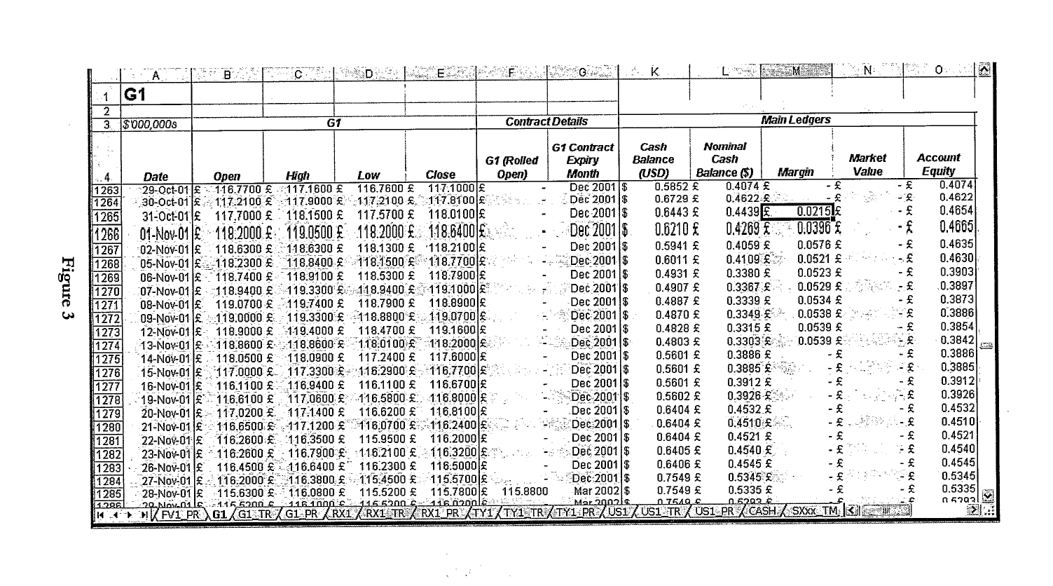

A snapshot of the main ledgers used in trading a long-term model applied to the long gilt future is shown in FIG. 3, below. FIG. 3 is a Spreadsheet Output Showing Main Ledgers for a Virtual Local Currency Account

Phases of Operation (Summary)

The xTest system operates around the notion of a timeslot. One timeslot may cover a single trading day (as for the examples shown here) or a shorter period, such as a minute. Event-driven operation (per tick, with a fallback minimum operation of e.g. once per day to ensure rebalancing etc. operates) is also possible.

During each timeslot (for the subsequent discussion, without loss of generality, we shall refer to this period as referring to a single trading day; the reader should bear in mind that the time period can be set to be arbitrarily large or small as the strategy requires) the xTest system advances through five distinct phases. These phases are as follows:
Pre-processing. This is where any interest, borrow etc that is due is calculated and the account ledgers updated as a result of the cashflows thereby created. There are no position updates during this phase.
Open. This is where any transactions that are scheduled for the start of the period take place (e.g. at the open for daily data), on the basis that input data is provided in an OHLCV (Oi) format for each period. This refers to the prices data with the opening price (O) at the start of the period, highest price reached during the period (H), the lowest price reached during the period (L) and the closing price for the period (C); the volume of contracts transacted during the period (V) and (optionally) the open interest (Oi) outstanding at the end of the period (if known). As will be discussed later, pre-emptive allocations are also possible during any of these three transaction phases (open, intraperiod or close); however, they are omitted here for simplicity. These transactions create cashflows that cause updates to the ledgers from the pre-processing phase, and similarly position movements that change the net position information from the prior phase. As will be discussed later, pre-emptive allocations are also possible during any of these three transaction phases (open, intraperiod or close); however, they are omitted here for simplicity.
Intraperiod. This is where any transactions that occur due to the triggering of a stop mid-period take place (e.g intraday for daily data). The transactions create cashflows that cause updates to the ledgers from the Open phase, and similarly create position movements from the prior net position information.
Close. This is where any transactions that occur at the end of the period take place (e.g. at the close for daily data). The transactions create cashflows that cause updates to the ledgers from the intraperiod phase, and also create position movements from the prior net position information.
Rebalancing. This is where any fees and charges are applied, and also (importantly) where the money management algorithm is called to move money between accounts. These transactions create cashflows that cause updates to the ledgers from the close phase. There are no position updates during this phase.

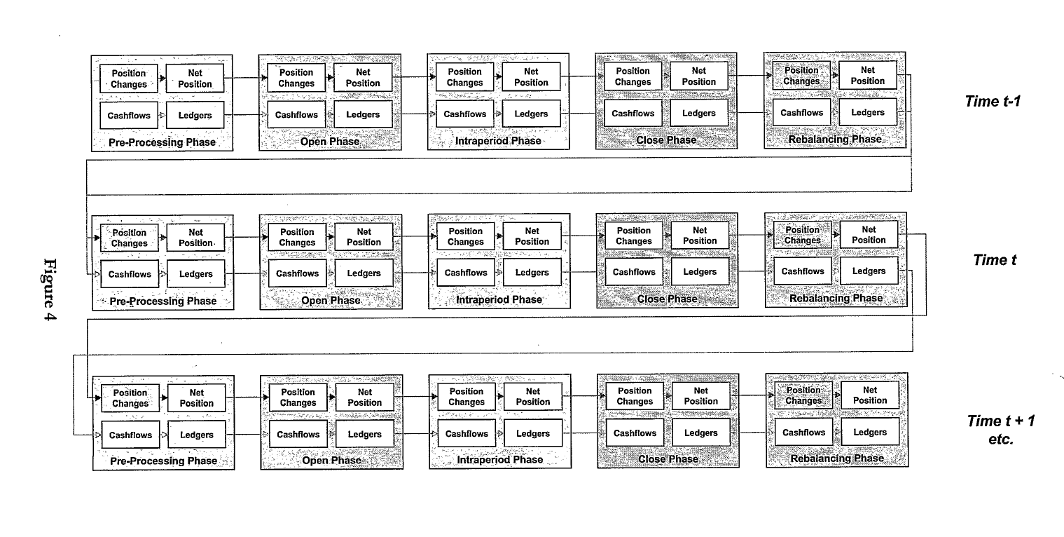

As may be appreciated, what we have is a series of transactions that update the state from the previous step, as shown in FIG. 4. We shall return to the specific details of the cashflows contemplated in each phase shortly. Next, however, we will look at the ‘big picture’ overview of the xTest domain model and flow.

The xTest Model of Money Management

One critical aspect to the xTest framework is that it creates a distinction within money management between capital allocation and trade sizing. This is essential to allow the operation of the system in a hierarchical manner without circularity.

A key difficulty that we aimed to address with this approach is the ‘scheduling problem for trades’; which is to say—we do not want to simply allocate all our capital amongst strategy instances that have current trade recommendations at any given timestep (particularly if initiated trades can span a reasonable time period before being closed out)—since another strategy instance may detect a profitable trade in a subsequent timestep and be ‘starved’ of capital. However, given the potential costs (particularly if the instruments are somewhat illiquid) do we necessarily want to close out or lighten trades in progress automatically to provide capital for the new recommendation, as this might incur significant costs. And yet, we also do not want to keep full capital allocations to every strategy that might issue a trade recommendation, since some strategies may have very long periods between activity, which would result in inefficient use of capital. As may be appreciated, the trade scheduling problem is a complex one, and in general, different managers will want to tackle it in a variety of ways. Therefore, what is required from a portfolio backtesting framework such as xTest, is a domain model that makes expression of solutions to the trade scheduling problem as efficient a task as possible.

Money Management—Overview of xTest's Conceptual Framework

xTest's domain model splits ‘money management’ into the following three distinct steps:
1. Capital allocation, in which free capital is moved between strategy instances non-preemptively based upon expectations of each strategy instance's general trading performance;
2. (Optional) pre-emptive allocation, in which, given each instance's current suggestions for trades (and statistical ex ante qualifications of performance thereof), positions may be lightened for some instances to make free capital to reallocate to said new trades; and
3. Trade sizing, in which the strategy instance's ex ante trade performance estimates, relative to that strategy's general performance expectation, is used to determine how much of the allocation should be utilized on a specific trade.
   The xTest Flow in Detail

In more detail, xTest assumes the following trading ‘flow’:
Strategy instances are polled at the commencement of the rebalancing phase (via an API) to generate ex ante estimates of their general trading performance. These estimates characterize the strategy instance in terms of expected return, expected trade recommendation occurrence, and expected holding period (more detail on this follows later).
This information is fed (during each time-step at the end of the close phase) to an allocator routine. (The allocator also has access to any risk analysis of the current portfolio that has been computed, such as the VaR analysis described later.) The job of the allocator is to decide how much capital (free cash) should be moved to each strategy instance. This movement may not be immediately possible due to trades in progress having capital that is ‘tied up’ in an existing trade: the framework operates under the presumption that such capital should not be forcibly released (at this step of the proceedings). xTest provides a number of standard algorithms for allocation (including a mean variance optimizer) but also provides an API that allows the user to add their own allocation routine.
Where one instance of a strategy covers multiple accounts (as is the case when basket trading, for example), the strategy instance must provide a sub-allocator (again, general routines are made available by xTest, but it is more likely that the user will wish to implement their own in this circumstance, as the correct split between e.g. basket components will be a highly strategy-dependent decision in most circumstances). The end goal is to have target allocations that apply to accounts. All allocations are subject to upper and lower constraints and relative sizing and group constraints that are set by the user.
Once allocations are decided (at the portfolio and strategy instance level (if required), they are executed (to the extent possible) during the rebalancing phase). These are noted as cashflows in the various accounts, and affect the ledgers of those accounts.
We now enter the next timeslot, and the pre-computation phase commences, to calculate bookkeeping entries such as interest, borrow etc. from the previous period(s).
When an actual trade recommendation from a strategy triggers, by default it must then operate within the boundaries of the current (actual) allocation. How much of that allocation to put at risk on a particular trade is termed the trade sizing problem.
During trade sizing, it is possible (given certain assumptions) that e.g., an infrequent but profitable strategy which has just triggered a trade recommendation should take capital from a trade that is currently running (or from spare allocation currently assigned to other strategy instances, or a mixture of the two). This preemptive allocation is possible (but optional) in the xTest framework. During the three transaction phases for a timestep (open, intraperiod and close), each trading strategy instance with a current or potential trade must return a PDF return time series for that current (or potential) trade (the strategies are polled at the start of the phase). This PDF series shows how the trade is expected to evolve over time. If this information is not provided explicitly, then a new trade's PDF time series will be inferred by the framework anyway, from the data provided at strategy instance level. The PDF estimates may be conditional or unconditional (more commonly, unconditional estimates will be used). These PDF time series are then provided (at the start of each transaction phase) to a pre-emptive allocation routine, along with all the general strategy characterization PDFs. Once again, the xTest framework provides a standard set of such routines, and an API is provided so that the user may supply their own. The pre-emptive allocator may also be disabled completely if desired.
The allocations from the pre-emptive routine are mandatory (unlike the main allocator, the recommendations for which are only followed to the extent that cash is free to move and not tied up in an existing trade). This may cause certain existing positions to be lightened or close out completely during that transaction phase, simultaneously to the new positions being taken and the cash being reallocated between accounts. (Where pre-emptive allocation is disallowed, no rebalancing takes place during transaction phases).
Once the pre-emptive allocation is decided (if any), each strategy instance must calculate the amount of the final allocation to utilize in the current trade. Clearly, if there is no current trade for a given instance, then the sizing will be 0, and the cash will remain unused and, (in general, in the absence of the user specifying a more sophisticated money management rule) will simply earn interest at the standard short term rate (e.g. overnight LIBOR). A number of standard trade sizing routines are provided, or the user may supply their own to an API provided by the xTest framework.
In general, the framework will ensure that the correct mean allocation to each strategy has been provided, given the general strategy characterization. Trade sizing then takes place relative to this allocation (assuming that the allocation has been conditioned to the mean strategy returns; Other conditioning assumptions are possible, but the mean is the most straightforward.). In other words, a given trade should be sized, such that a mean expectation trade relative to the strategy PDF would utilize the full capital allocated at the normal risk weighting for the strategy, and so that trades with a higher or lower than mean expectation are scaled appropriately. Therefore, trades with a >mean expectation will be allocated potentially more than 100% of the capital, requiring borrowing in the case of e.g. a long equity position, or a higher-than-usual margin-to-equity in the case of a future, and contrariwise for a <mean expectation trade. This is an important point. In the case of e.g. a future traded by a trend-following strategy, we might have on average 10% of our allocated capital tied up as margin, and the rest fallow. A trade at the upper end of the PDF might then be sized at e.g. 25% of allocation; at the lower end 5% of allocation. For equities and other instruments with actual market value, a mean expectation trade will take up 100% of the allocation; lower expectation trades may easily be dealt with but higher expectation trades require borrowing (if long).
Absolute position limits constraining trade sizing may be imposed by the user.
A trading strategy instance must issue (at the beginning of each transaction phase in a timestep) a stop schedule for each instrument that it trades. This schedule provides a list of data of the form <price, number of units>, which specifies in effect the price points at which to buy or sell contracts of the underlying (and, as we shall see, how many contracts to buy or sell). Units are a metric to express an undiversified level of risk in a standardized manner across different instruments. One unit is the number of contracts that would lose 1% of the allocated capital on an (unconditional) 1 standard deviation move of the underlying instrument (in price terms) against the position. (N.B., when simulating trades the xTest framework generates a dynamic estimate of margin requirements, slippage and spread. This is discussed in more detail later in the text.)
This methodology allows for dynamic trade sizing (e.g., scaling into and out of a trade as a function of the conditional forward expectation of return), as each strategy instance is given a chance to vary its stop schedule at the beginning of each transaction phase.
The framework then executes any trade(s) for that transaction phase (open, intraperiod or close) as determined by the current account state, the stop schedule issued by the associated strategy instance, and the trade data for the underlying for that period. (Note that when processing the ‘intraperiod’ phase, stops are processed pessimistically, since there will be a range of data (the low to the high) that the price will have passed through with an unknown transition path, whereas the open and close prices for the timeslot are known exactly). Slippage, spread and commissions are recorded for any trade that is executed (we describe the methodology in more detail later in the document). The xTest system also contains the capability to deal with instruments such as futures which have expiry dates but where the strategy may wish to maintain a position on the underlying. The default methodology is for the trade to be ‘rolled’ into the contract with the highest open interest; this will be the general case; however, the strategy instance may chose to ‘lock’ trading to a specific maturity etc. (important when trading spreads, for example).
Once the three transaction phases have been completed, the timestep is concluded by processing the rebalancing phase. This is where we came in, so the cycle has completed; however, it is worth pointing out here one additional point that was omitted in the exposition previously for clarity: during the rebalancing phase, as a further risk control, a diversified risk estimate for the portfolio is computed. Various different estimators may be utilized here (and again, the user may specify an estimator); the xTest system natively supports VaR (value at risk) as a metric, which is made available to the allocator routine. This can be used to impose e.g. an absolute VaR limitation on the system, regardless of underlying exposures. This limit is imposed by reducing the size of a unit in the trade sizing methodology, which reduces risk across the board. By default, this unit sizing will only take place when the position would resize anyway, but it may be forced to operate preemptively if desired.

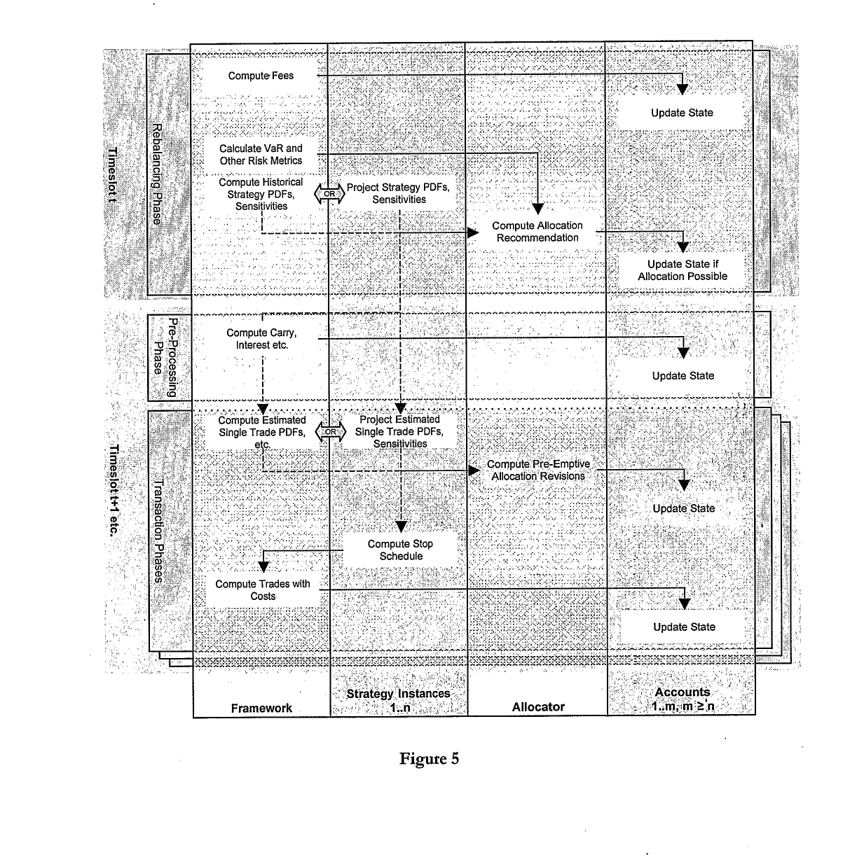

A summary of the xTest flow is shown in FIG. 5, below, which shows major Data Flows in the xTest Framework, Showing Split Between Capital Allocation and Trade Sizing

Further Details of the xTest Model

We will now examine some aspects of the system in a little mote detail.

Estimates of a Strategy Instance's Expected Performance

As briefly mentioned in the overall description of the xTest flow, the framework maintains an estimate of a given <strategy instance, instrument>'s average future performance per unit time. This estimate is broken out as a set of PDFs (probability distribution functions), viz.:
A PDF describing the arrival of new trade recommendations (partitioned into long and short side). Only one ‘side’ need be provided in the case of a non-directional strategy (this will often be the case where a single strategy instance spans multiple accounts). This may be expressed unconditionally (the most usual case), or conditional upon certain risk factors.
A PDF describing the expected length (in terms of time) of a trade. Trade recommendations are partitioned into long and short side. Again, may be expressed unconditionally or conditionally.
A PDF describing the expected trade returns (as a function of capital utilized in a trade, for example as margin on a future, or of the capital tied up in an equity position). Again, partitioned into long and short side, and again expressed conditionally or unconditionally.
   The xTest framework provides three ways for this data to be generated, as follows:
1. It can be returned directly from the trading strategy instance as a result of an API (application programming interface) call. If the strategy does not support this ‘alpha estimation’, then:
2. The strategy can simply be run in a forward Monte Carlo mode by the framework, in which the framework (i.e., xTest) evolves a number of potential future histories based upon either a random/bootstrapped selection of historical ‘segments’ for the asset prices in question, or a newly generated ‘virtual’ forward history that utilizes evolution of the underlying risk factors, and the strategy instance provides a set of trading decisions for those future histories (note, however, that the latter approach is unlikely to be successful for most strategies since the idiosyncratic behaviour on which the strategy depends will not be present). The results are then processed to provide the necessary information. Alternatively:
3. The xTest framework, based upon the prior historical trading simulation of the system itself, can build its own versions of these PDFs (using Bayesian inference for continuous distributions, starting from conservative priors).

Note that xTest does not simply reduce the information to a ‘mean return per period plus covariance’, as some of current art offerings do. This is critical because the ‘distortion’ of the strategy matters, both in terms of return and the frequency of trading. Consider, for example, a systematic trend following strategy; such a system will attempt to cut losing trades rapidly, whilst allowing winning trades to run. As such, it will produce (assuming it is working correctly, and there are suitable trends to exploit present in the underlying instrument) highly skewed, option-like return PDFs, which will be badly served under assumptions of normality.

More Detail on the Operations of Each Backtest Phase

The Pre-Processing Phase

During this phase, the system tracks the following cashflows:
Margin interest (in terms of costs of borrowing applied to margin loans, which are collateralized by the market value of the instruments traded themselves). This is distinct from the notion of performance bond margin applied to futures etc.
Borrow charges. These are fees paid on short positions on certain instruments (e.g. equities) in exchange for the extension of the loan of the securities by the owner.
Interest earned on cash. Cash (generally speaking, this will include cash pledged as performance bond margin on a futures or similar contract) will earn interest at a short-term rate, which is recorded here.
   The Transaction Phases (Open/Intraperiod/Close)

During any of the three transaction phases, the following cashflows are tracked:
Transaction flows. This is the capital requited to purchase a long position, or paid on adoption of a short position. Generally, only instruments with a market value will have a transaction flow on opening or closing (e.g., futures do not).
Commission flows. Costs associated with a particular trade that are not ‘bundled’ into a spread on the underlying instrument's price.
Period settlement flows. There are no periodic settlement flows from an equity (other than dividends); however, instruments such as futures are subject to daily settlement (generally on a T+1 basis, that is, there is a day's lag in applying the flow from when it is incurred due to the profit or loss of the underlying exposure).
Margin (performance bond) flows. Exchanges stipulate a minimum amount of margin that must be posted for any given futures contract. Gains add (due to the settlement flows) to this account (although xTest assumes that these are automatically swept back to cash unless otherwise instructed). Similarly, losses subtract from the posted margin. When the margin falls below the maintenance margin level, additional capital must be posted to make good the shortfall.
Margin (collateralized borrowing) flows. Financed positions in (e.g.) equities, where the instrument's market value is used as collateral for the loan, are subject to minimum collateralization requirements (imposed by e.g., government agencies). Should the price of a long equity position that is margined fall below the minimum margin requirements for example, a margin call will be issued, and the requisite movement of funds is measured by this cashflow.
Note that rebalancing flows due to pre-emptive rebalancing may also be generated during this phase, if permitted (see earlier discussion).
   The Rebalancing Phase

Finally, during the rebalancing phase, the following cashflows are tracked:
Currency flows. Where an instrument is not traded in the ‘root’ currency, cash must be moved into the local currency to meet purchases, daily settlement outflows etc.; similarly, excess funds in the local currency will generally be moved back into the root currency to avoid taking unintended currency risk. xTest allows users to supply currency management routines to e.g. ‘sweep’ excess foreign currency (above the minimum margin requirements) on a regular basis.
Management fee flows. Hedge funds generally charge a fixed percentage of assets under management per year, amortized over a more frequent basis, as a management fee. xTest allows this to be customized and tracks the cash movements through this cashflow entry.
Performance fee flows. Hedge funds generally also charge a performance fee, which is a percentage (generally) of new profits (i.e., a ‘high watermark’ is used). Movements due to this are recorded in this cashflow. Note that xTest also manages the high watermark automatically, to ensure that the ‘net results’ quoted by the test are accurate (at an average of 2% management and 20% of new profits performance fees, the drag imposed by a fund's fee structure can be considerable).
Rebalancing flows. Perhaps most importantly, rebalancing flows are tracked. These always sum to 0 across all strategy instances, and represent the free cash moved between strategies under the direction of the allocator, as previously discussed.
   More Details on Account State

As briefly described, the system tracks for each account a number of key elements of state, which are updated as trading progresses. Some of the more important of these elements are:
The number of contracts currently held, long or short (for each phase xTest also records the prior number of contracts held).
The number of contracts expressed in units (see 21, above, for a definition of units).
The minimum performance bond margin required, if trading futures or similar instruments. Note that this must be estimated when backtesting, since the exchange's historical margin requirements are not generally available. As performance margins are generally a rough proxy for volatility (and vice versa), xTest provides a mechanism to calibrate current margin requirements (which are known) against current volatility, and thereby create a transfer function, which can in turn be inverted to derive historical margin requirement estimates from historical volatility. This is a unique feature to the xTest platform and is generally a lot more accurate than simply using fixed margins (e.g., taking the current margin as fixed for all history).
The minimum account equity required for margin on instruments with market value (this is the other meaning of margin, namely, a loan which is collateralized in part by the market value of the security which the loan is used to purchase). Margin requirements for short sales of instruments with market value are also tracked under this state variable.
The average entry price for the current position.
The trade mid-price for any trade closed during the phase.
The actual trade price for any trade closed during the phase.
The trade mid-price for any trade opened during the phase.
The actual trade price for any trade opened during the phase. Note that it is entirely possible for a single phase to contain both a previous position exit and a new position entry, if it swings through from a long to a short net position, or vice versa.
The ‘mid-point’ equity (used to record the equity when a long position is unwound but the short not yet taken, or vice versa). This is also why we need to record the mid-point equity.
The mark-to-market price of the current position (this assumes full slippage and spread so that a position opened will show an immediate mark loss). Users can supply their own mark-to-market routine for less liquid instruments.
The market exposure of the current position, which is the number of contracts x mark price of contract x contract value per point. All positions, even those that do not have a market value (e.g. futures) will generally have a market exposure. N.B., it is generally not very useful to consider market exposure for futures, since their nominal value may be very high relative to expected volatility; this is true for e.g., interest rate futures.
Liquidity budget consumed. The xTest framework maintains the concept of a ‘liquidity budget’ for the underlying instruments traded. It regards 10% of average daily volume or 1% of average open interest in the most liquid contract, to be the ‘100% liquidity quota’ for each instrument (whichever is the greater). This operates as a safeguard when trading, to prevent positions being placed in simulation in historical conditions where this would have meant becoming too large a portion of the market (the percentage limits are variable by the user).
Greeks. The standard greeks (theta, gamma, delta, vega, rho) are tracked for positions with optionally.
   Calibrating Trading Costs

To ensure that results of backtesting are credible, it is important to calibrate trading costs correctly. If costs are marked too heavily marked up, valid trading strategies (particularly short-term ones) will be unreasonably penalized; if not sufficiently severe (the more insidious case), strategy profitability will be inflated, possibly severely.

The base xTest system provides a mechanism for estimating slippage and spread based upon the volatility of the underlying instrument. However, this may be further improved when the system is actually taken live, by noting the actual trading costs that are incurred as a function of price, volatility, time and volume. These are then compared with the basic model's predictions (assuming that the backtest is run in parallel with the live trading system) through the use of a Kalman filter, which allows the internal estimates of trading costs used for each instrument to ‘lock’ rapidly to a close approximation to the actual transfer function used. See e.g., Greg Welch and Robert Bishop, An Introduction to the Kalman Filter, for an overview of the Kalman filtering technique. The estimate generated (the ‘predict’ step of the filter) is the slippage and spread for the next trade; the correction is fed back with respect to the actual slippage and spread measured. A standard discrete-time (linear stochastic) Kalman filter is used in the basic xTest methodology, but the use of a more sophisticated (non-linear, extended Kalman filter) is also envisaged.

This ‘predict/correct’ aspect applied when running the simulation in ‘real time’ against an actual trading record is novel and provides a way to ensure that the system future simulations are as accurate on costing as possible (and indeed, once trained, the filter can be used without updates on historical data, or it is also possible to ‘train’ it at using historical points where the actual slippage on a particular instrument was measured and that measurement is available).

Additional Features of the xTest Architecture

Although we have now touched briefly on the main features of the xTest architecture, the following additional points are valuable to understand:
Each account can be explicitly exported to Excel (or other compatible spreadsheet), providing the user with a breakdown of the cashflows, transactions, current ledgers and state for each phase and timeslot. This enables very detailed subsequent analysis to be performed. Summary tables showing trade-by-trade histories, overall strategy performance, VaR by account and overall, currency movements, liquidity usage, desired and actual allocation, monthly returns, high-level performance statistics (e.g. Sharpe and Sortino) are all exportable to spreadsheet form.
Automation of testing is straightforward. As the system is implemented within a technical computing environment, parameter optimization (should that be the user's goal) is easily accomplished.
Integration with various data sources is easily managed through the use of standard third-patty libraries (for example, in the initial embodiment in MATLAB, a standard toolbox exists to enable data to be imported from Bloomberg and other real-time datafeeds).
The system is very rapid (even when processing a large number of instruments strategy instances/timeslots) as the underlying implementation environment is designed for precisely the task performed, namely, large scale matrix operations.
As just mentioned, data is held internally as matrices (with timeslot and phase constituting the major dimensions, and all cashflows, transactions, ledgers and other state being stored as a structure within each cell). This format makes the data extremely straightforward to store in commercial third-party relational databases for further retrieval or processing.
The xTest framework as described here can actually form the basis for a real-time trading platform, not just a backtesting engine. This is highly important as it allows the use of (literally) the same strategy and money management algorithms to be used in production as were tested in simulation, avoiding the pitfalls of translation that can otherwise occur.
   Advantages of the xTest System

Let us now consider how the xTest system matches up to the fifteen simulation requirements of multi-strategy funds that we described at the beginning of our analysis:
1. Specify strategies programmatically. xTest provides this, and utilizes an API (in the initial embodiment) that operates in an existing, third-party programming environment (MATLAB).
2. Specify money management programmatically. The xTest framework specifically addresses this point. As has been described earlier, xTest splits money management into non-preemptive asset allocation, (optional) pre-emptive asset allocation, and trade sizing. All of these aspects can be programmed, and critically, the framework supports this complex operation in a straightforward manner for the user
3. Run multiple strategies concurrently. xTest enables strategies with very different trading patterns, frequency of trading, holding pattern and return profile to be managed concurrently. ‘Multi-instrument’ strategy instances are supported, and dynamic strategy instance creation/deletion is also supported.
4. Deal with futures etc., not just equities. xTest provides the ability, as we have discussed, to deal with instruments that have a market value, as well as those that are simply settled daily.
5. Handle foreign exchange, interest, sweeps, etc. As discussed, each account in xTest is associated with a local currency, and can be operated either in ‘virtual’ mode (where performance bond margin is posted in the root currency) or actual mode (where margin etc. is genuinely held in the local currency). The user can specify the methodology for moving cash into and out of accounts; the standard framework supports common practices such as daily sweep. Transaction costs are automatically booked at the relevant cross rate plus a configurable cost. Interest rates (at local LIBOR minus a user-specified spread) are tracked on all cash, according to parameters set by the user. All behaviour may be explicitly user programmed, if requited.
6. Feedback portfolio metrics of risk into money mgt . . . A full analysis of the portfolio is made available to the allocation and trade sizing algorithms.
7 . . . . Including Value at Risk (VaR). A VaR calculation is performed regularly and is made available through the API to the allocator (and also for trade sizing, if required). A secondary control loop is built explicitly into the framework, allowing the user to set an overall VaR constraint (this is independent of the main money management loops); this can exercise control by lowering the size of a ‘unit’—the standard undiversified quantum of risk defined on page 21—across all accounts.
8. Simple full export into spreadsheet format. The full timestep and phase data structure of the xTest engine may be exported into Excel (or a similar spreadsheet that supports comma separated files). As described in the previous section, a large number of summary pages are also generated for export. The level of detail exportable is significantly in advance of what other systems provide (given the methodical nature of the framework's data model and stepwise approach).
9. Track margin requirements over historical tests. As we discussed, xTest offers the ability to create a volatility-driven margin estimate for use in simulation, rather than simply taking the current margin as invariant. Margin requirements (performance bond margins, that is) do change over time and can have a significant effect on a strategy's backtested performance. While the approach used by xTest is not perfect (because for example, there are periods when margins are raised significantly to quell speculation, even through volatility of the underlying has not much changed), it does provide a quantifiable improvement in accuracy.
10. Comprehensive trading cost analysis (inc. volatility). xTest breaks out all costs associated with a trade, and explicitly models slippage and spread as a fraction of the single-period volatility of the underlying instrument by default (this percentage of daily volatility to use can be set by the user, or overridden programmatically if desired). One further point worth making here is that xTest allows the user to set a definition of ‘fast periods’—there are periods that exceed the averaged historical volatility by a certain margin (the default is three standard deviations); during a fast period, the system default behaviour allows that both slippage and spread be increased by a given factor.
11. Liquidity constraints. By default, xTest limits trading to 1% of average open interest or 10% of average daily volume (whichever is the greater); this limit may be modified by the user. It constitutes a ‘liquidity budget’ that is always monitored (it is a key element of an account's state). The user may modify these liquidity limits or override them programmatically if desired.
12. Deal with hedge fund fees (inc. high watermark). xTest manages this process automatically, although complex fee patterns can be programmed explicitly if required (use of esoteric forms of hurdle rate, for example).
13. Operate in end of day and intraday nodes. As discussed, the xTest framework is based around the concept of timeslots, which are themselves broken up into phases. Timeslots may correspond to a day, an hour, or any other arbitrary length of time (alternatively, they may be tied to events). Therefore, maximum flexibility of analysis with respect to tenor is maintained.
14. Ability to calibrate by running in parallel with real trades. xTest provides a feedback loop when used in parallel with real trades, whereby the cost of trading (in terms of slippage and spread) is progressively modelled through the use of a feedback process (a Kalman filter). The more accurate model derived thereby can subsequently be utilised for future historical backtesting, if desired.
15. Efficient expression of portfolio dynamics. It is here that the xTest framework brings the most significant benefit. By separating out the processes of allocation and trade sizing within an explicit domain model (with corresponding data structures and flow), xTest makes implementation of sophisticated portfolio-based backtesting straightforward for end users (namely, systematic, multi-strategy hedge funds).

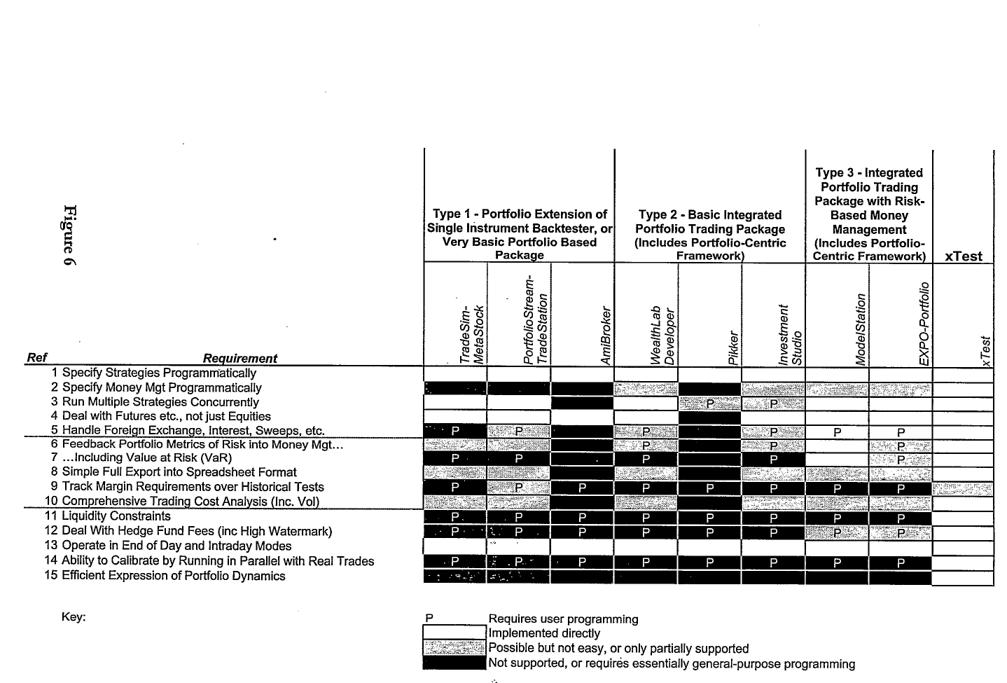

The table below at FIG. 6 graphically depicts how xTest performs when compared with other portfolio backtesting products currently available:

Summary

In this document, we began by considering the portfolio simulation/backtesting requirements of a modern, systematic multi-strategy hedge fund. We determined fifteen key requirements likely to be of high importance to such a user, and provided a rationale for each.

We then outlined three categories of portfolio backtesting system currently available commercially, together with some examples of each category. Upon analysis, it was demonstrated that the current art fails to satisfy many important requirements of the multi-strat fund user.

Subsequently, we then presented the xTest framework, and showed why its approach makes it a highly efficient platform within which to model and test complex, portfolio-based trading systems. Key design elements discussed included the separation of money management into allocation, pre-emptive allocation and trade sizing, the timeslot/phase model for data processing, the strategy instance/instrument/account object model, and the cashflow/ledger/transaction/position state data structure.

Finally, we reviewed the xTest framework against the original fifteen key requirements and demonstrated that it represents a significant step forward for practitioners, providing as it does considerable advances in methodology, representation and efficiency when compared to the prior art.

xTest Key Features

An integrated backtesting framework that separates allows explicit user control of the money management function as well as the trading function. While backtesting platforms that support programmed money management are known in the art, the xTest framework differs in its explicit separation of the concepts of capital allocation (advance and pre-emptive) and trade sizing.
A backtesting dataflow with corresponding data structures wherein the backtesting process is modelled as a series of timesteps, each of which is broken up into phases. This methodology allows testing in any tenor (daily, hourly, or even event-driven).
Within this concept, the idea of trading accounts, which contain ledgers and state (see text for details); each phase has a set of allowed transactions that can operate on state and cashflows that can operate on ledgers. All of the data for an account is stored in matrix format for efficient storage in a relational database, and efficient processing within a matrix-based language (such as MATLAB).
The ability to handle local and ‘root’ currencies within an account, with the option to have an explicit currency management routine provided by the user.
Flexibility of data-structure to enable a strategy instance to be associated with a single account or with multiple accounts (e.g. for basket trading); ability for an underlying instrument to be traded (in separate accounts) by multiple strategies.
The concept of a backtesting system that requires a trading strategy not only to provide its trading decisions (given appropriate data input and parameters), but also estimates of its ‘overall’ expected trading performance (characterised as PDFs, which may be conditional or unconditional, for trade recommendation arrival, trade holding time and return; please see text), and also (when recommending a specific trade) the return estimate PDF time-series for that particular trade.
   The ability for the framework to infer these distributions where the underlying strategy cannot provide them.
   The ability to use a Monte Carlo simulation to create estimates of these PDFs, using either historical data (bootstrapped or sampled) or random generation via risk factors.
The use of an allocator routine to decide the amount of capital to assign to each strategy instance, and then a sub-allocator to assign to each account. Next, the ability for the allocator (based upon individual trade assessments at each timestep from the strategy instances) to (optionally) pre-emptively allocate capital from other accounts (including potentially shutting out running trades), and then (based upon the relationship between the individual trade predicted ex ante performance and the general predicted strategy performance), to drive a trade sizing (putting at risk a percentage of the allocated capital—may be >100% in some cases).
The use of a continuous VaR (value at risk) monitor on current positions, that can be made available to the various allocation and trade sizing routines, and which can also be used to run an overall risk control loop, whereby a master VaR target is set, and when this is exceeded then a global scaling factor is decreased according to an appropriate loop gain, to lower the size of all contracts.
   Similarly, the ability to use the risk control in the reverse manner, where a failure to meet the target risk causes an increase in the scaling factor.
The estimation of a volatility→performance bond margin transfer function that enables a more accurate simulation.
The use of an historical slippage and spread for trading that is based upon volatility.
The ability to conform the slippage and spread model to actual trading, by running the backtesting system in parallel with actual trading, and then using a Kalman filter to create a better estimate. This better model (with the update loop off, obviously) can then be used for subsequent backtesting.
The provision of a liquidity constraint, whereby the backtested system will not allow trading of more than a certain % (or other function) of volume or open interest.
Although the system is described as targeted at multi-strats, they are simply a case where the need is strongest; other hedge funds, and even standard CTAs (futures traders) should find the platform beneficial.
It is also important to point out the direct financial benefit to multi-strats that flows from being able to trial strategies within such as framework. Given the evolutionary nature of system design, this is very much an ongoing, not ‘one-off’, advantage.
The backtester can also be extended to an actual trading system

1. Method of storing data used in backtesting a computer implemented investment trading strategy;
wherein an object based data representation is used, the data representation comprising instances of a software object implementing a particular systematic trading strategy (‘strategy instances’), with a strategy instance being paired with a tradable instrument;
and wherein the data for each pairing of a strategy instance and an instrument is stored in a matrix format.

2. The method of claim 1 comprising the further steps of (i) estimating a general trading performance associated with each strategy instance in order to allocate free capital to different strategy instances and (ii) separately determining how much of a given allocation associated with a given strategy instance should be utilised on a specific trade associated with a specific instrument.

3. The method of claim 1 in which each strategy instance can be interacted with via an API.

4. The method of claim 1 in which the step of estimating a general trading performance associated with a software object is performed by polling that object over an API to determine one or more of an expected return, expected trade recommendation occurrence and expected holding period for that object.

5. The method of claim 1 in which multiple pairings, each between a strategy instance and an instrument, can be backtested in parallel.

6. The method of claim 1 in which the backtesting process is modelled as a series of timeslots, each of which is broken up into phases.

7. The method of claim 6 in which a portfolio is represented as a set of accounts, which each contain ledgers and state; each phase of the backtesting process has a set of allowed transactions that can operate on state and cashflows that can operate on ledgers.

8. The method claim 7 in which all of the data for an account is stored in a matrix format in a relational database, and is processed within a matrix-based language.

9. The method claim 7 in which local and ‘root’ currencies can be handled within an account, with the option to have an explicit currency management routine provided by the user.

10. The method of claim 7 in which the data representation is designed to be flexible in order to enable a strategy instance to be associated with a single account or with multiple accounts or to give the ability for an underlying instrument to be traded in one or more separate accounts by multiple strategies.

11. The method of claim 1 in which backtesting requires a strategy instance not only to provide its trading decisions, but also estimates of its expected trading performance, characterised as probability distribution functions (PDFs) for trade recommendation arrival, trade holding time and return, and also (when recommending a specific trade) the return estimate PDF time-series for that particular trade.

12. The method of claim 11 in which these estimates can be inferred automatically where the underlying strategy instance cannot provide them.

13. The method of claim 11 in which these estimates can be inferred automatically using a Monte Carlo simulation to create estimates of these PDFs, using either historical data (bootstrapped or sampled) or random generation via risk factors.

14. The method of claim 1 including the use of an allocator routine to decide the amount of capital to assign to each strategy instance, and then a sub-allocator to assign to each account.

15. The method of claim 14 in which the allocator (based upon individual trade assessments at each timestep from the strategy instances) can preemptively allocate capital from other accounts (including potentially shutting out running trades, and then (based upon the relationship between the individual trade predicted ex ante performance and the general predicted strategy performance), to drive a trade sizing.

16. The method of claim 1 including the step of using a VaR (value at risk) monitor on current positions, that can be made available to the various allocation and trade sizing routines, and which can also be used to run an overall risk control loop, whereby a master VaR target is set, and when this is exceeded then a global scaling factor is decreased according to an appropriate loop gain, to lower the size of all contracts.

17. The method of claim 16 further comprising the step of using risk control in the reverse manner, where a failure to meet the target risk causes an increase in the scaling factor.

18. The method of claim 1 further comprising the step of using an estimation of a volatility→performance bond margin transfer function that enables a more accurate simulation.

19. The method of claim 1 further comprising the use of an historical slippage and spread for trading that is based upon volatility.

20. The method of claim 19 further comprising the step of conforming the slippage and spread model to actual trading, by running the backtesting system in parallel with actual trading, and then using a Kalman filter to create a better estimate.

21. The method of claim 20 in which this better model can then be used for subsequent backtesting.

22. The method of claim 1 further comprising the use of a liquidity constraint, whereby the backtested system will not allow trading of more than a certain % (or other function) of volume or open interest.

23. The method of claim 1 in which an actual trading system is created based upon the backtesting method.
